(19) United States
(12) Patent Application Publication
(10) Pub. No.: US 2005/0177390 A1
(43) Pub. Date: Aug. 11, 2005

(54) Method and system for collecting, managing and reporting feedlot cattle data and feed additive consumption data

(76) Inventors: Joseph Young, Olathe, KS (US); Marcel Sarzen, Dunwoody, GA (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/046,318

(22) Filed: Jan. 28, 2005

Related U.S. Application Data
(60) Provisional application No. 60/539,685, filed on Jan. 28, 2004.

(51) Int. Cl. G06F 17/60

(52) U.S. Cl. 705/1

(57) ABSTRACT

A method and system for collecting, managing and reporting feedlot cattle data and feed additive consumption data is provided. In particular, the present invention is directed to a method and system for collecting data including demographic data, animal health data, feedlot performance data, feed data, and carcass data from standard accounting systems, validating the data, normalizing the data using mapping and matching protocols, and reporting the data.

### CROSS-REFERENCE TO RELATED APPLICATIONS

This application claims priority to U.S. Provisional Patent Application Ser. No. 60/539,685, filed Jan. 28, 2004, which document is hereby incorporated by reference to the extent permitted by law.

### BACKGROUND OF THE INVENTION

The present invention is directed to a method for collecting, managing and reporting feedlot cattle data and feed additive consumption data. In particular, the present invention is directed to a method of collecting information gathered from standard livestock accounting and medical systems, managing the information, and reporting the information in a useful format.

The beef industry is constantly evolving and, recently, began consolidating. As a result, cattle and beef marketing methods have evolved at a rapid rate. Branded beef, while still a small portion of the total beef supply, is growing in volume as packers and retailers look for ways to differentiate and add value to their products. Many “blockbuster” patents covering animal health products are also expiring thereby leading to competition from generic manufacturers. These generic manufacturers are looking for ways to acquire market share from the pioneer manufacturers while managing price erosion.

This environment in the beef industry is driving a need for accurate, timely information and knowledge that enables feedlot managers, marketing managers, loan managers, and the like, to guide their companies. While the beef industry currently uses sophisticated accounting and medical system software to track individual feedlot or packer performance, there is a need in the art for a system to collect data from many sources in a meaningful way so as to provide valuable knowledge and information to the players in this ever-changing industry in order to aid cattle feeders, packers, animal health companies, and the like to identify strengths, weaknesses, opportunities and niches that may be exploited.

Accordingly, there is a need in the art for a data collection and validation system that interfaces with industry accounting and medical systems to facilitate the collection of feedlot and carcass data and dramatically reduce manual data collection requirements. Moreover, there is a need in the art for a system configured to collect and process large amounts of industry-wide livestock data in order to provide industry-standardized reports.

### BRIEF SUMMARY OF THE INVENTION

A method for managing livestock data is provided wherein the method include the steps of collecting raw livestock data from a plurality of livestock data acquisition locations, determining through an iterative process the validity of the raw livestock data, normalizing the validated data using a conversion factor based upon the type and unit of measurement for the data, and presenting the normalized data in a report format.

The present invention also includes a system for managing livestock data, means for accessing and collecting livestock data from legacy software applications, means for transmitting the data to a livestock data management system, means for validating the data, means for normalizing the data, and means for reporting the data.

### BRIEF DESCRIPTION OF SEVERAL VIEWS OF THE DRAWING

FIG. 1 is a flowchart of the central controller of the present invention;

FIG. 2 is a flowchart of the user interface of the present invention;

FIG. 3 is a flowchart of the steps of the method of the present invention;

FIG. 4 is an illustrative screen shot of one embodiment of the present invention;

FIG. 5 is an illustrative report of one embodiment of the present invention;

FIG. 6 is an illustrative report of one embodiment of the present invention;

FIG. 7 is an illustrative report of one embodiment of the present invention;

FIG. 8 is an illustrative report of one embodiment of the present invention;

FIG. 9 is an illustrative report of one embodiment of the present invention;

FIG. 10 is an illustrative report of one embodiment of the present invention; and

FIG. 11 is an illustrative report of one embodiment of the present invention.

### DETAILED DESCRIPTION OF THE INVENTION

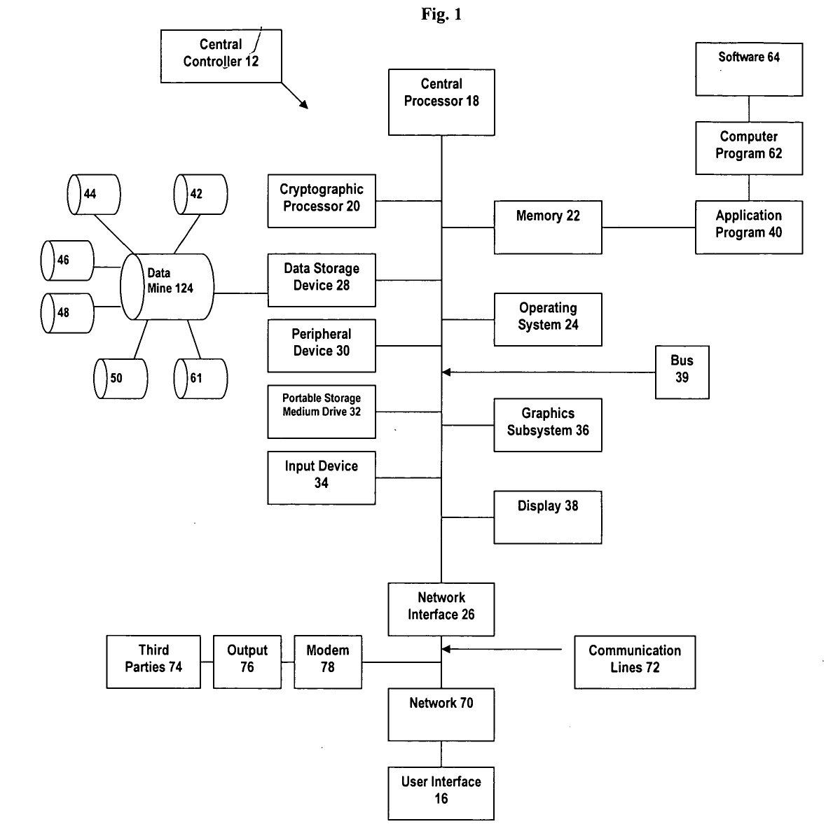

The feedlot data management system 10 of the present invention includes a central controller 12, a transmission means 14, and a user interface 16. As used herein, a user may be an individual, a feedlot, a packer, a corporation, a partnership, a government, or any other entity. FIG. 1 illustrates a high-level block diagram of central controller 12 which may used to implement the method of the present invention. Central controller 12 includes a central processor 18, an optional cryptographic processor 20, memory 22, operating system 24, network interface 26, data storage device 28, peripheral device(s) 30, portable storage medium drive(s) 32, input device(s) 34, graphics subsystem 36, and display 38. The components of central controller 12 are those typically found in general purpose computer systems, and are intended to represent a broad category of such computer components that are well known in the art.

In one embodiment, central controller 12 may be a conventional personal computer or computer workstation with sufficient memory and processing capability to perform the necessary functions of the present invention. In another embodiment, central controller 12 operates as a web server, both receiving and transmitting queries and requests generated by users. Regardless of its architecture, central controller 12 must be capable of high volume transaction processing and performing a significant number of mathematical calculations in processing communications and repository searches. One skilled in the art will also appreciate that the functionality of central controller 12 may also be distributed over a plurality of computers such as network of computers or a plurality of stand-alone computers. Central controller 12 may be configured in a distributed architecture wherein the repositories and processors are housed in separate units or locations. Some controllers perform the primary processing functions and contain, at a minimum, both memory and a general processor. Each of these controllers is attached to a WAN hub which serves as the primary communication link with the other controllers and interface devices. The WAN hub may have minimal processing capability itself, serving primarily as a communications router. Those skilled in the art will appreciate that an almost unlimited number of controllers may be supported and other types of hubs known in the art or developed in the future for similar purposes may be used instead of a WAN hub. This arrangement yields a more dynamic and flexible system that is less prone to catastrophic hardware failures affecting the entire system.

Central processor 18 may contain a single microprocessor or it may contain a plurality of microprocessors for configuring central controller 12 as a multi-processor system. Examples of currently available processors that may be suitable as central processor 18 include 64 bit AMD opteron and 64 bit Itanium from Intel. Equivalent processors may also be used. However, one skilled in the art will appreciate that newer and faster models will be developed and would be suitable for use in the present invention.

Cryptographic processor 20 is a processor that supports the authentication of communications from and to users and central controller 12. Cryptographic processor 20 is also suitable for providing anonymity in transactions, secure processing of electronic transactions, secure electronic data interchange (EDI), Internet commerce servers and all other applications that require high-volume transactions and maximum security. Examples of suitable, currently available apparatus include the IBM® PCI Cryptographic Coprocessor, the Okiok RAC/M IX ICP Cryptographic Processor and the like. Equivalent processors may also be used. However, one skilled in the art will appreciate that newer and faster models will be developed and would be suitable for use in the present invention.

Memory 22 includes random access memory (RAM), dynamic random access memory (DRAM), read-only memory (ROM) as well as high-speed cache memory. Memory 22 may also include an application program 40 that stores, in part, instructions and data for execution by central processor 18. If the system 10 of the present invention is wholly or partially implemented in software, including a computer program, memory 22 stores the executable code when in operation.

Controller 12, as shown in FIG. 1, illustrates operating system 24 as a Windows®-based platform available from Microsoft Corporation that may be used for implementing the method of the present invention. However, numerous other platforms can also suffice for use as operating system 24, such as Macintosh-based platforms available from Apple Computer, Inc., platforms with different bus configurations, networked platforms, multi-processor platforms, other personal computers, personal digital assistants (e.g., Palm Pilot®, Blackberry®, Clié®, 3Com, etc.), workstations, mainframes, navigation systems, and the like.

Network interface 26 is the gateway to communication with users through user interface 16 as well as with other users of system 10. Network interface 26 may be a network interface card for interfacing central controller 12 to a network, a modem, or the like. Conventional internal or external modems may also serve as network interface 26. Network interface 26 supports modems at a range of baud rates from 1200 upward, but may combine such inputs into a T1 or T3 line if more bandwidth is required. In a preferred embodiment, network interface 26 is connected with the Internet and/or any of the commercial on-line services such as America Online, MSN, etc., allowing users access from a wide range of on-line connections. Several commercial electronic mail servers include the above functionality in, for example, mail software packages designed to link people and information over enterprise networks and the Internet. These types of products are platform independent and utilize open standards based upon Internet protocols. Users can exchange messages with enclosures such as files, graphics, video and audio. The system also supports multiple languages. Alternatively, network interface 26 may be configured as a voice mail interface, web site, BBS, or electronic mail address.

Data storage device 28 is a non-volatile storage device for storing data, software and instructions for use by central processor 18 and is typically implemented with a magnetic disk drive or an optical disk drive. Data storage device 28 also contains data repositories used in the processing of data in the present invention, including a data mine 124 or other data repository containing a demographic data repository 42, a animal health data repository 44, a feedlot performance data repository 46, a feed data repository 48, a carcass data repository 50, and a user account data repository 61. Demographic data repository 42 maintains demographic data 52 on cattle, either individually or in groups (lots or pens), with fields containing information both pre-feedlot arrival and post-arrival such as gender, genetics, geographic origin, buyer, health score, hide color, frame score, gene markers, gene mapping indicators, breed types, delivering trucking company, ranch of origin, current location, feedlot location, slaughter location, pre-arrival health protocols, pre-arrival nutrition protocols, pre-arrival pharmaceutical usage, and age.

Animal health data repository 44 maintains animal health data 54 for cattle after arrival in a feedlot such as pharmaceutical usage, biological agent usage, and health practices protocols. Pharmaceutical usage data may include antiinfectives, antimicrobials, growth promotants, antibiotics, steroidals, anti-inflammatories, estrogen-based pharmaceuticals, parasiticides, and any other pharmaceutical that is or anti-infectives, antimicrobials, growth promotants, antibiotics, steroidals, anti-inflammatories, estrogen-based pharmaceuticals, parasiticides, and any other pharmaceutical that is or may be administered to the animal during its stay in the feedlot. Biological agents may include any biologicals typically administered as vaccinations such as IBR, BVD, BRSV, and viral diseases. Health practices may include de-homing, tail docking, castration, ear tagging, identification (electronic and/or visual tags), pregnancy, and any other health practice being conducted at an individual feedlot. Dosages of any pharmaceuticals or biologics administered to an animal may also be included in animal health data 54.

Feedlot performance data repository 44 maintains feedlot performance data 56 such as head in, head out, pay weight out, average daily gain, in weight, out weight, days on feed, mortality, purchase cost, total receipts, total charges, feed and yard age charges, veterinary/medical charges, other charges, pounds gained, head days, feed pounds, moisture, lot of closeout, sex type, date closed, head days, feedyard of closeout, feedyard name, feedyard phone, start period, end period, source name, and any other type of information that might be useful in determining feedlot performance or requested by a user.

Feed data repository 48 maintains feed data 58 such as feed rations by lot, pen, or individual animal, feed composition including, for example, additives, grains, protein, micro-ingredients, minerals, growth promotants, antibacterials, beta-agonists, parasiticides, direct fed microbials, bacteria, and any other ingredient in the animal feed. Feed data 58 may also include the individual rations, brand labels, dosages, or any other feed-based information that may be desired by a particular user.

Carcass data repository 50 maintains carcass data 60 such as packer name, plant location, head, yield, total carcass weight, prime, CAB, choice, select, no roll, standard, dark cutter, other quality grades, hard bones, heavy weight, light weight, condemned, packer carcass ID, packer lot, customer number, customer lot, customer animal ID, final quality grade, final yield grade, program, individual carcass, gender, hot carcass weight, marbling score, quality grade, fat thickness, ribeye area, internal fat, yield grade, comments, or any other carcass data that may be desired by a particular user.

Individual or grouped user account data 59 may also be stored in data mine 124 in a user account data repository 61 or some other suitable data storage location. User account data 59 may include, but is not limited to, the user's name, location, business type, username, password, contact information, veterinarian, nutritionist, corporate profiles, and feedlots associated therewith, and any other information desirable in identifying a particular user. User account data 59 may also be linked to any one of data 52, 54, 56, 58 and 60 that have been previously provided by the particular user so that a user may access archived data already entered into controller 12. As one skilled in the art will appreciate, any suitable type of software may be used to create and manage these repositories.

In another embodiment, data storage device 28 may also store application program 40 for the purpose of loading program 40 to memory 22. Computer software, instructions or data, including data 52, 54, 56, 58, 59 and 60 may also be stored in central processor 18 rather than data storage device 28.

Controller 12 may further include peripheral device(s) 30, portable storage medium drive(s) 32, input device(s) 34, graphics subsystem 36 and display 38. For purposes of simplicity, the components shown in FIG. 1 are depicted as being connected via a single bus 39. However, one skilled in the art will appreciate that the components may be connected through one or more data transport means. For example, processor 18 and memory 22 may be connected via a local microprocessor bus, and data storage device 28, peripheral device(s) 30, portable storage medium drive(s) 32, and graphics subsystem 36 may be connected via one or more input/output (I/O) buses.

Peripheral device(s) 30 may include any piece of hardware or computer support device, such as an input/output (I/O) interface, used to add additional functionality to central controller 12. Other examples of peripheral device(s) 30 include, but are not limited to, printers, scanners, disk and tape drives, microphones, speakers, joysticks, plotters, and cameras.

Portable storage medium drive(s) 32 operates in conjunction with a portable non-volatile storage medium, such as a floppy disk, CD-ROM, or other computer-readable medium, to input and output data and code to and from central controller 12. In one embodiment, program 40 or data 52, 54, 56, 58, 59 and 60 is stored on a portable medium, and is then inputted to central controller 12 via portable storage medium drive 32.

Input device(s) 34 provides a portion of a user interface with central controller 12. Input device(s) 34 may include an alpha-numeric keypad for inputting alphanumeric and other key information, or a pointing device, such as a mouse, a trackball, stylus, wheel, cursor or direction keys. Such devices provide additional means for interfacing with repositories 42, 44, 46, 48 and 50.

In order to display textual and graphical information, central controller 12 includes graphics subsystem 36 and display 38. Graphics subsystem 36 receives textual and graphical information and processes the information for output to display 38. Display 38 may include a cathode ray tube (CRT) display, liquid crystal display (LCD), projection displays, other suitable display devices, or means for displaying, that enables a user to view data. Display 38 can be used to display data, component interfaces and/or display other information that is part of a user interface.

In a further embodiment, the present invention also includes a computer program 62 that includes a storage medium (media) component having instructions stored thereon which can be used to program a computer to perform the method of the present invention. The storage medium can include, but is not limited to, any type of computer-readable medium including floppy disks, optical disks, DVD, CD-ROMs, magnetic optical disks, RAMs, EPROM, EEPROM, magnetic or optical cards, or any type of media suitable for storing electronic instructions.

Stored on any one of the computer-readable medium (media), the present invention may also include software 64 for controlling both the hardware of central controller 12 or processors 18 and 20, and for enabling central controller 12, processor 18 and cryptographic processor 20 to interact with a human user or other mechanism utilizing the results of the present invention. Software 64 may include, but is not limited to, device drivers, operating systems and user applications. Ultimately, such computer-readable media further includes analyst software 68 for performing the method of the present invention. In a preferred embodiment, software 68 is downloaded to central controller 12 and stored in memory 22 as part of application program 40. For the purposes of simplicity, all references herein to application program 40 and software 64 include software 68. However, it will be appreciated by those skilled in the art that software 68 may also be stored and executed separately from application 40.

As illustrated in FIG. 1, central controller 12 is connected via network interface 26 to transmission means 14 such as a network 70 (e.g., an intranet, the Internet, or other network), across communications lines 72. Preferably, communications lines 72 are dedicated lines (e.g., LAN, WAN, standard dial-out telephone line, satellite, dedicated lease line, DSL) with a frame relay (or point-to-point) connection. Central controller 12 may also be directly linked to third party computer systems 74 rather than communicating with central controller 12 through network 70. Third party computer systems 74 may be, for example, a mainframe or PCs of at least XX486 processing ability (e.g., Pentium CPU) having at least one gigabyte drive, 16 megabytes of RAM, with typical I/O accessories including a keyboard, mouse, and printer or similar workstation. Each third party computer system 74 and central controller 12 and, more specifically, an output device(s) or a server(s) 76, also have a modem 78 (e.g., CSDSU, T1 communication, DSL, satellite or cable modems) for coupling to communication lines 72 and enabling communications between central controller 12 and third party computer system 74.

Data storage device 28, output device or server 76 and memory 22 may be implemented by one digital processor 18. In that case, consolidation, scheduling, initial and subsequent segmenting of end users and execution of working programs are accomplished through the one processor 18. In using the present invention, end users may be assisted by a third party. Alternatively, rule-based expert systems may be similarly employed in the present invention to provide dynamic end user behavioral and characteristics segmentation.

In a preferred embodiment, user interface 16 is a conventional personal computer having, at a minimum, an input device, such as a keyboard, mouse or conventional voice recognition software package, a display device, such as a video monitor, a processing device such as a CPU, and a network interface such as a modem. A cryptographic processor may also be included for stronger authentication protection. These devices interface with central controller 12. Alternatively, user interface 16 may also be a voice mail system, or other electronic or voice communications system such as a PDA, digital telephone, pocket personal computer or the like.

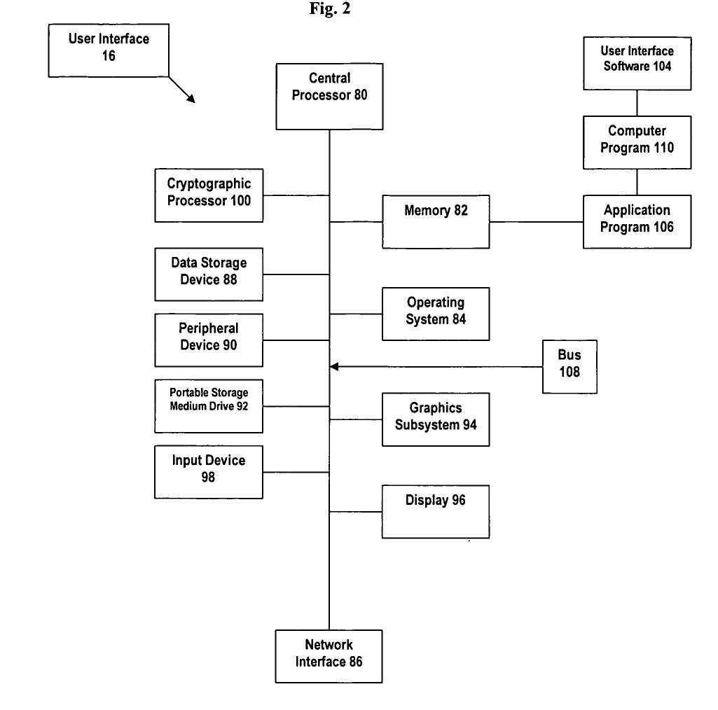

Referring now to FIG. 2, user interface 16 is described in more detail. User interface 16 may include a central processor 80, a memory 82, an operating system 84, a network interface 86, a data storage device(s) 88, a peripheral device(s) 90, a portable storage medium drive(s) 92, a graphics subsystem 94, a display 96, and an input device(s) 98. Cryptographic processor 100 may also be added for stronger authentication and verification capabilities.

Central processor 80 may contain a single microprocessor, such as a Pentium microprocessor, or it may contain a plurality of microprocessors for configuring user interface 16 as a multi-processor system. Cryptographic processor 100 is a processor that supports the authentication of communications to and from user interface 16 and central controller 12. Cryptographic processor 100 is also suitable for providing anonymity in transactions, secure processing of electronic transactions, secure electronic data interchange (EDI), Internet commerce servers and all other applications that require high-volume transactions and maximum security. Examples of suitable, currently available apparatus include the IBM® PCI Cryptographic Coprocessor, the Okiok RAC/M IX ICP Cryptographic Processor and the like. Equivalent processors may also be used. However, one skilled in the art will appreciate that new and faster models will be developed and would be suitable for use in the present invention.

Memory 82 includes random access memory (RAM), dynamic random access memory (DRAM), read-only memory (ROM) as well as high-speed cache memory. Memory 82 may also include an application program 106 that stores, in part, instructions and data for execution by central processor 80. If user interface 16 is wholly or partially implemented in user interface software 104, including a computer program 110, memory 82 also stores the executable code when in operation. Operating system 84 is shown in FIG. 2 as a Windows®-based platform available from Microsoft Corporation. However, numerous other platforms can also suffice for use as operating system 84, such as Macintosh-based platforms available from Apple Computer, Inc., platforms with different bus configurations, networked platforms, multi-processor platforms, other personal computers, personal digital assistants (e.g., Palm Pilot®, Blackberry®, Clié®, 3Com, etc.), workstations, mainframes, navigation systems, and the like.

Network interface 102 is the gateway to communication with central controller 12. Network interface 102 may be a network interface card for interfacing user interface 16 to a network, a modem, or the like. Conventional internal or external modems may also serve as network interface 102. In a preferred embodiment, network interface 102 is connected with the Internet and/or any of the commercial on-line services such as America Online, MSN, etc., allowing users access to central controller 12 from a wide range of on-line connections. Several commercial electronic mail servers include the above functionality in, for example, mail software packages designed to link people and information over enterprise networks and the Internet. These types of products are platform independent and utilize open standards based upon Internet protocols. Users can exchange messages with enclosures such as files, graphics, video and audio. The system also supports multiple languages. Alternatively, network interface 102 may be configured as a voice mail interface, web site, BBS, or electronic mail address.

Data storage device 88 is a non-volatile storage device for storing data, software and instructions for use by central processor 80 and is typically implemented with a magnetic disk drive or an optical disk drive. Data storage device 88 may be used for archiving demographic data 52, animal health data 54, feedlot performance data 56, feed data 58, user account data 59 and carcass data 60. In another embodiment, data storage device 88 may also store application program 106 for the purpose of loading program 106 to memory 82. Computer software, instructions or data, including data 52, 54, 56, 58, 59 and 60 may also be stored in central processor 80 rather than data storage device 88.

User interface 16 may further include peripheral device(s) 90, portable storage medium drive(s) 92, graphics subsystem 94, display 96, and input device(s) 98. For purposes of simplicity, the components shown in FIG. 2 are depicted as being connected via a single bus 108. However, one skilled in the art will appreciate that the components may be connected through one or more data transport means. For example, processor 80 and memory 82 may be connected via a local microprocessor bus, and data storage device 88, peripheral device(s) 90, portable storage medium drive(s) 92, and graphics subsystem 94 may be connected via one or more input/output (I/O) buses.

Peripheral device(s) 90 may include any piece of hardware or computer support device, such as an input/output (I/O) interface, used to add additional functionality to user interface 16. Other examples of peripheral device 90 include, but are not limited to, printers, scanners, disk and tape drives, microphones, speakers, joysticks, plotters, and cameras.

Portable storage medium drive 92 operates in conjunction with a portable non-volatile storage medium, such as a floppy disk, CD-ROM, or other computer-readable medium, to input and output data and code to and from user interface 16. Program 106 or data 52, 54, 56, 58, 59 and 60 may be stored on a portable medium, and then inputted to user interface 16 via portable storage medium drive 92.

In order to display textual and graphical information, user interface 16 includes graphics subsystem 94 and display 96. Graphics subsystem 94 receives textual and graphical information and processes the information for output to display 96. Display 96 may include a cathode ray tube (CRT) display, liquid crystal display (LCD), projection displays, other suitable display devices, or means for displaying, that enables a user to view data. Display 96 can be used to display data, component interfaces and/or display other information that is part of a user interface.

Input device(s) 98 provides a portion of a user interface with user interface 16. Input device(s) 98 may include an alpha-numeric keypad for inputting alphanumeric and other key information, or a pointing device, such as a mouse, a trackball, stylus, wheel, cursor or direction keys. Such devices provide additional means for interfacing with user interface 16 and, ultimately, central controller 12.

In a further embodiment, the present invention also includes a computer program 110 that includes a storage medium (media) component having instructions stored thereon which can be used to program a computer to perform the method of the present invention. The storage medium can include, but is not limited to, any type of computer-readable medium including floppy disks, optical disks, DVD, CD-ROMs, magnetic optical disks, RAMs, EPROM, EEPROM, magnetic or optical cards, or any type of media suitable for storing electronic instructions.

Stored on any one of the computer-readable medium (media), the present invention may also include user interface software 104 for controlling both the hardware of user interface 16 or processor 80, and for enabling user interface 16 and processor 80 to interact with a human user or other mechanism utilizing the results of the present invention. Software 104 may include, but is not limited to, device drivers, operating systems and user applications. Software 104 is configured to interface with standard bunk readers or feedlot accounting and medical systems 112 such as Turnkey, Hi-Plains, Dalex, Advanced Computer Systems, Micro Beef, USI CattleXpert, Feedlot Solutions, Ltd., Feedlot Monitor by ISU Research Foundation, and Walco—ITA, Lextron—Micro Tech for easy transfer of data from these accounting and medical systems to software 104 for use in the method of the present invention. In a preferred embodiment, software 104 is configured to interface and collect information 114 from at least three different systems thereby providing an accounting system interface, a health system interface, and a feed/ration system interface. Information 114 may include, but is not limited to, any data collected or generated by standard systems 112.

Many commercial software applications are available to enable the communications required by user interface 16. When central controller 12 acts as a web server, conventional communications software such as the Internet Explorer web browser from Microsoft Corporation or the Netscape Navigator® web browser from Netscape Corporation may also be used. No proprietary software is required.

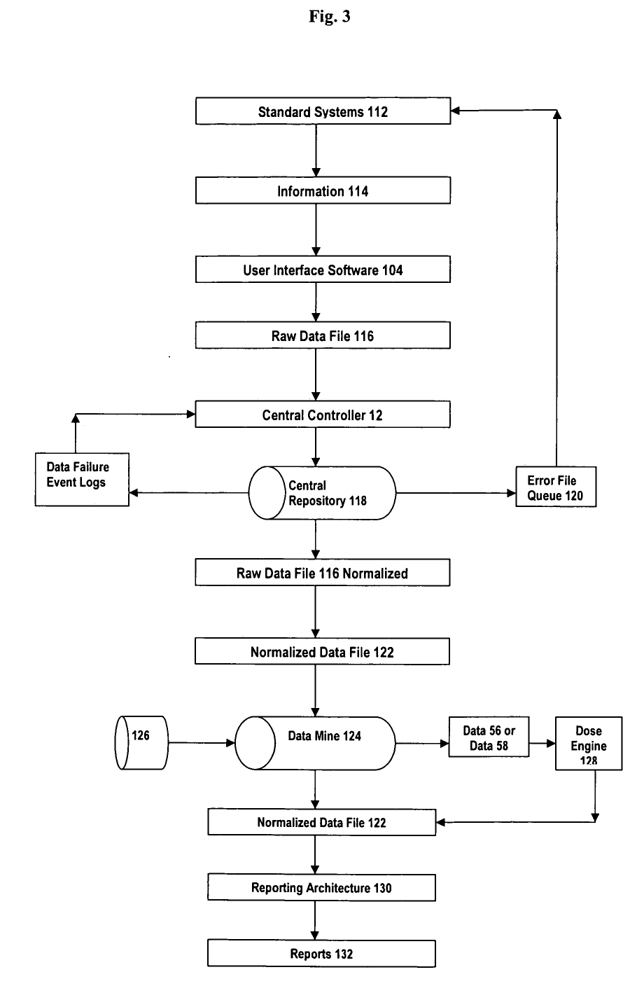

Referring now to FIG. 3, the present invention also provides a method for collecting, managing and reporting feedlot cattle data and feed additive consumption data. In accordance with the method of the present invention, information 114 is electronically transferred from standard systems 112 into user interface software 104 or information 114 may be manually entered into software 104 wherein information 114 is converted into at least one raw data file 116. Raw data file 116 may contain any of data 52, 54, 56, 58, 59 and 60 and may be collected, used or sent as individual files or batches. Raw data file 116 is then transferred to central controller 12 electronically via interface software 104 or electronically via standard electronic messaging programs. In a preferred embodiment of the present invention, raw data file 116 is transferred to central controller as XML following a Document Content Description File or Microsoft Excel files generated by a template from interface software 104.

When central controller 12 acts as a web server, a user may also log on to the central controller 12 in order to transfer raw data file 116. Central controller 12 is connected to a corresponding web site on the Internet thereby allowing the user to provide and request information through the interface of conventional web browser software such as Internet Explorer from Microsoft Corporation. The web site has a home page with topic selections and links (e.g., hypertext HTML technology) to application program 40 thereby triggering searches and initiating transfer of raw data file 116 and other desired information. In particular, for each topic or field selection there may be a respective hyperlink to application program 40 and optionally an event for initiating program 40. Upon the user's selection of a topic from the web page, the present invention applies the linked event, if any. If the criteria of the event are met (or if there is no initiating event), then the present invention executes the corresponding application program 40.

Rather than sending electronic mail or using web-based servers, users may also transfer information 114 or raw data file 116 via a telephone, fax machine, postal mail, or other off-line communication tool. For example, the user may call central controller 12 and be connected with an agent wherein the agent inputs information 114 or raw data file 116 into digital form by typing it into a terminal or other input device 34. The user may also fax copies of information 114 or raw data file 116 to an agent connected with central controller 12. In an alternative off-line embodiment, the user calls central controller 12 and is connected with a conventional interactive voice response unit which allows the user to enter information 114 or raw data file 116 without the aid of a live agent. The user initially selects from a menu of subjects using the touch-tone keys of a telephone, and then the call is either directed to a live agent specializing in that subject area, or the user is prompted for further information.

Regardless of the method or transmission means of inputting raw data file 116, upon receipt of raw data file 116 at central controller 12, raw data file 116 is collected in a central raw data repository 118. In a verification step, raw data 116 is then reviewed automatically, electronically or manually for errors or for data that is outside standard deviation parameters via a rules engine containing standard minimums and maximums particular to the type of data being reviewed. If raw data 116 contains errors or data outside standard deviation parameters, it is moved from the central repository 118 into an error file queue 120 and may be returned via any transmission means to the user for review and correction in order to resolve the error or deviation. Raw data 116 may then be re-transmitted to central controller 12 via any of the transmission means discussed above. As used herein, transmission means or transfer means includes any information or data transmission or transfer means currently known to the computer industry or hereafter developed. Data failure event logs and/or automated electronic messages may be generated to agents of central controller 12 for maintenance of the system and data evaluation. If raw data 116 does not contain errors or data outside standard deviation parameters, raw data 116 is then normalized for coding consistency. Normalized data file 122 is then transferred to data mine 124 or other repository where it is mapped and/or compared and/or validated using tolerances based on historical data file archive(s) 126 that may reside within data mine 124 or some other data repository. Historical data 126 may include any one or more of data 52, 54, 56, 58, 59 and 60 that has been previously entered into the system. During the mapping step, normalized data 122 may be converted into standardized units of measure. Product labels may be verified and standardized. Further, normalized data 122 may be inserted into pre-built tables, record-sets, forms, or other data collection tools for use in analysis or comparison against historical data 126. If normalized data 122 is a duplicate of data 52, 54, 56, 58, 59 or 60 already residing within data mine 124, it can be deleted or used to overwrite the previously existing data 52, 54, 56, 58, 59 and 60.

If normalized data 122 contains feedlot performance data 56 and/or feed data 58 wherein feed, ration, pharmaceuticals or biological agent data is being generated, the product label, manufacturer identification, feed type, pharmaceutical or biological agent type, active ingredient, administration method used, start date, end date and dosage given information may be processed through a calculated dose engine 128 to be validated. During validation, the dosages may be calculated and a record-set built. Labels may be then automatically applied to the calculated dosages. Alternatively, individual record validation of the particular dataset may occur and the product label validated. Validation tolerances for invalid record sets may be pre-determined so that invalid record sets can be identified and re-validated or calculated. A label audit step may also occur within data mine 124 or after the labels and dosages have been validated and transmitted to another repository for audit records. A similar process may be utilized for each of data 52, 54, 56, 58, 59 and 60 depending upon the needs of the user or analyst.

Normalized data 122 may also be compared against historical data 126 as well as other data sets included within normalized data 122 and mapped using data-type specific mapping or matching algorithms in order to link certain types of data to particular lots, pens or individual animals. For example, feed ration ingredient data for a particular lot may be linked, using a data-specific matching algorithm, to ration consumption data. Following mapping, normalized data 122 may then be compared against historical data 126 in order to update error and validation tolerances as well as provide information useful in a reporting step.

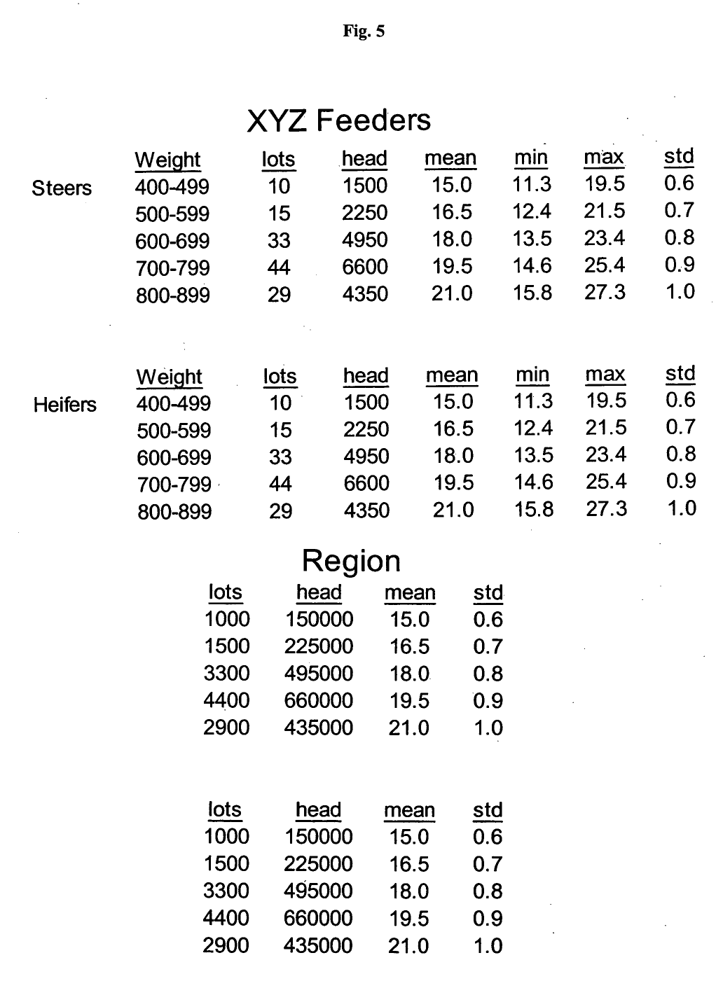

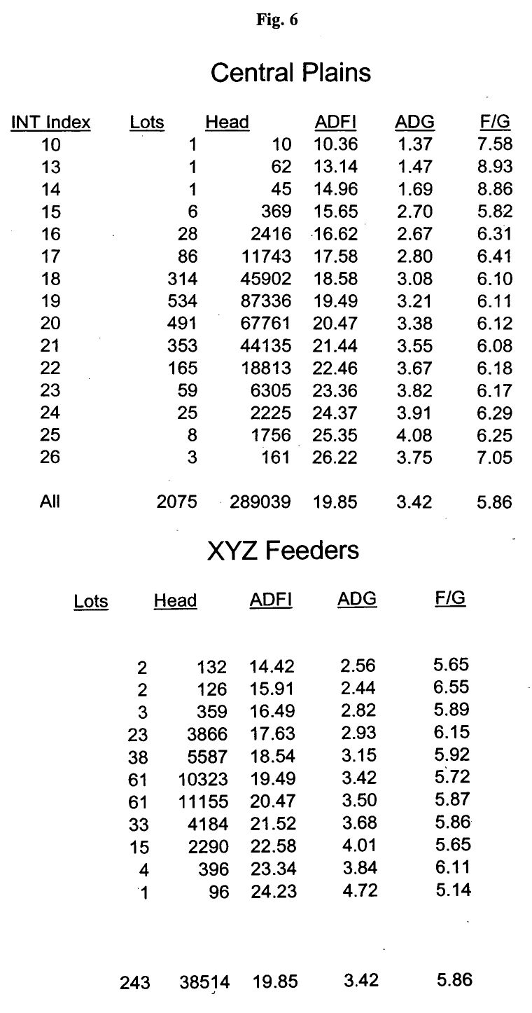

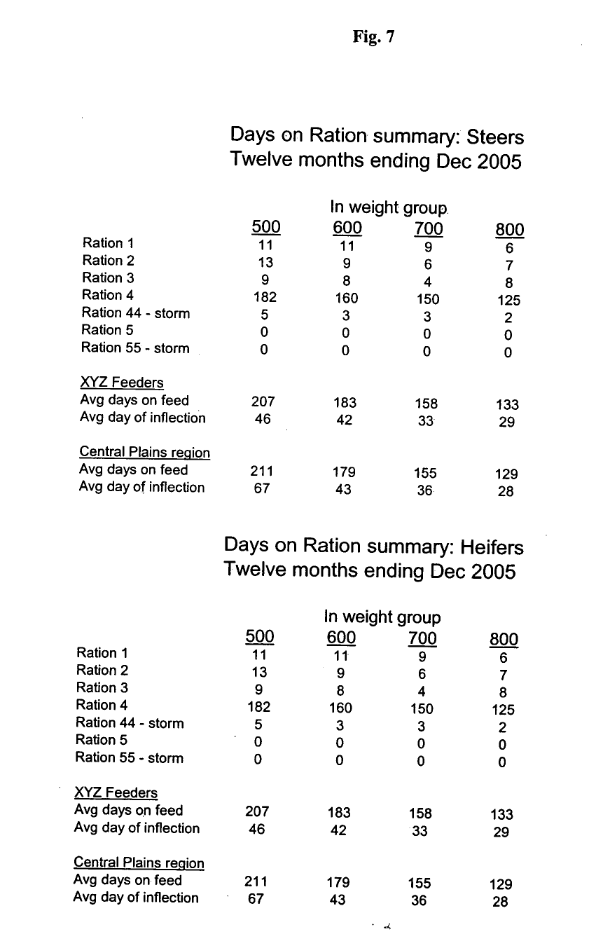

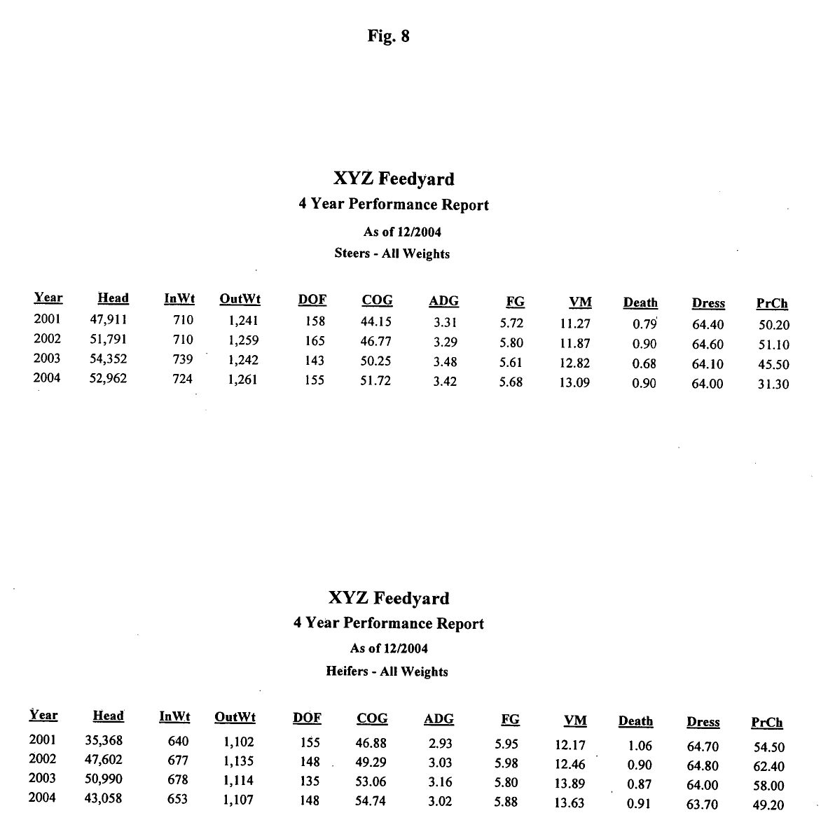

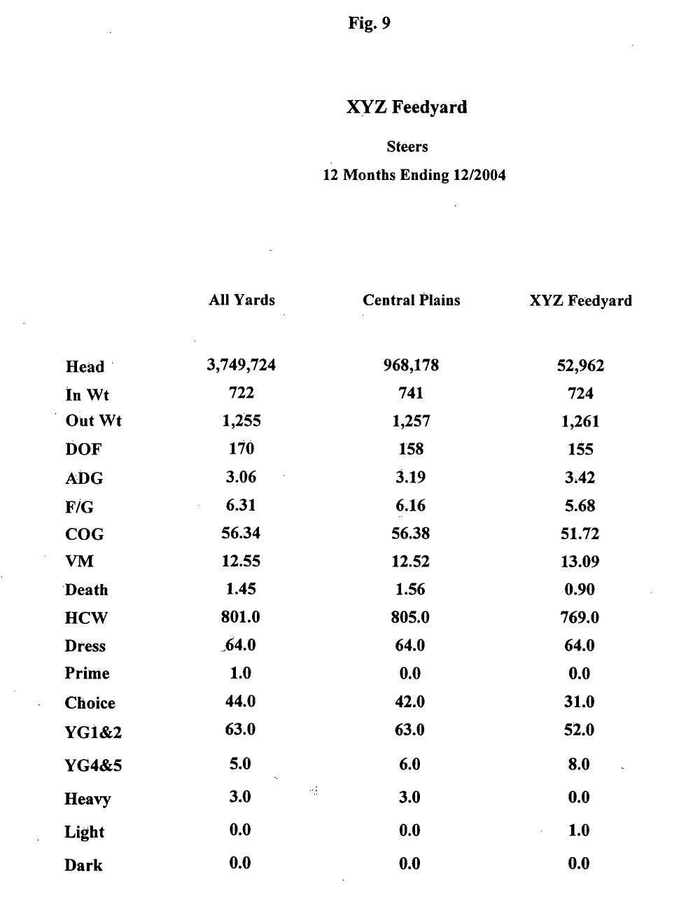

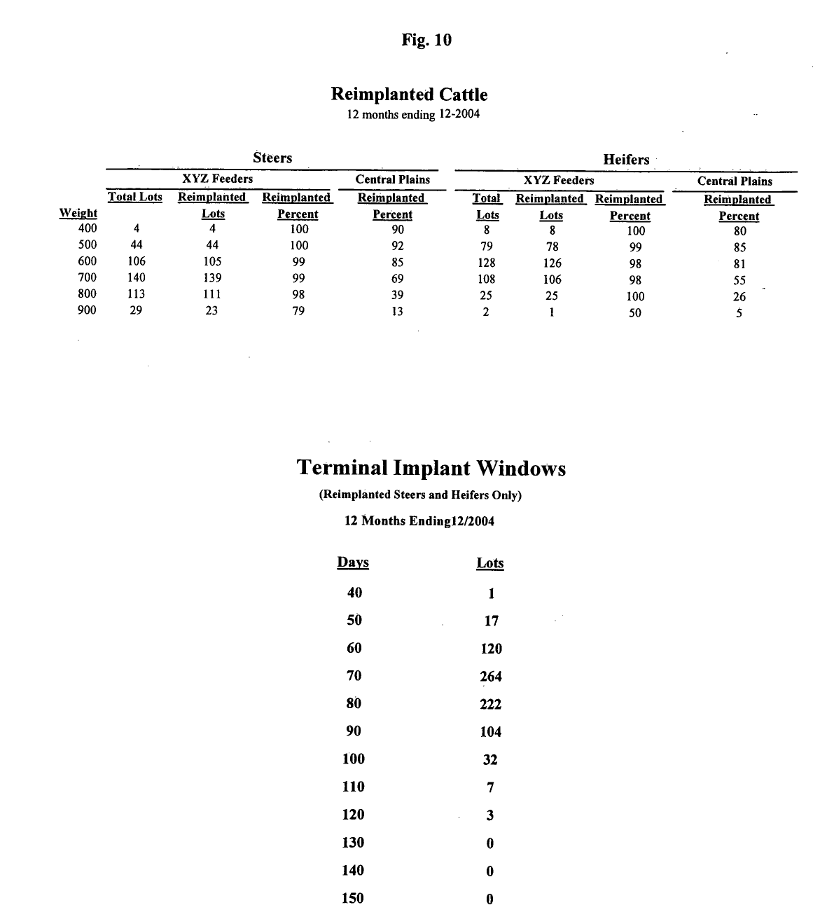

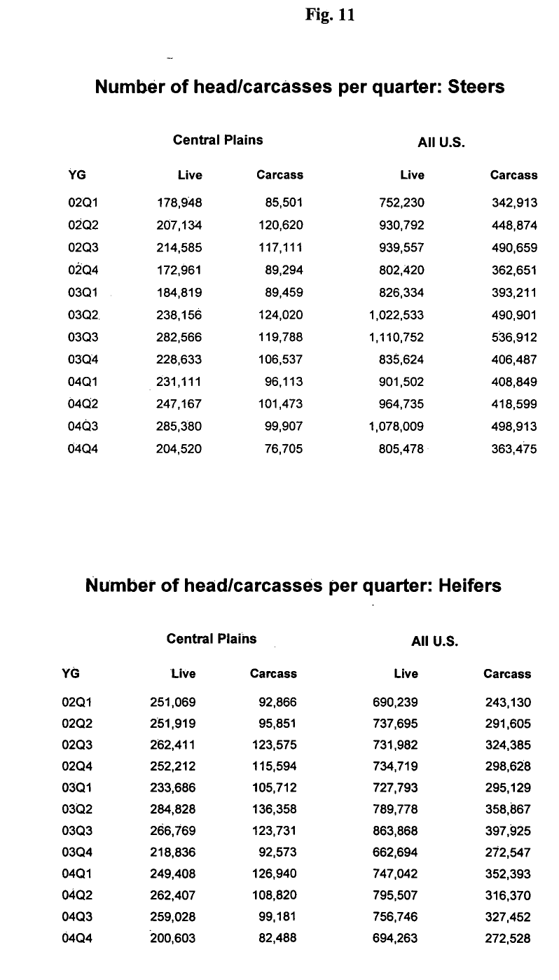

Following the comparison step, normalized data 122 is then transmitted to a reporting architecture 130. Reporting architecture 130 contains pre-built data groupings, report views, and report engines that allow reporting architecture to receive normalized data 122 and generate reports 132 containing information from normalized data 122 based upon the needs of the user or analyst such as those shown in FIGS. 5-11. For example, reports 132 may be generated as data files, charts, tables, or any other reporting format that a user or analyst may require. In addition to normalized data 122, reports 132 may contain feedlot location (state, region, country), corporate information, date ranges, and the like. Reports 132 may also contain matched data such as a feed ration and feed ingredient report showing all ingredients and amounts of feed consumed by a particular animal, lot or pen. Similarly, a particular animal's (or pen or lot) carcass data could be matched against that animal's feedlot performance, feed data, health data, and the like. Thus, reports 132 may be generated in response to the request of a user or analyst desiring monthly or quarterly performance reports from a particular feedlot, groups of feedlots, a particular packer, groups of packers, animal health companies, and the like or an overview of all data collected. Reports 132 may then be transmitted to a user or analyst via any transmission means desired in any report format desired. Reports 132 may be particularly useful for determining what feedlot products have actually been consumed and the performance of the feedlot associated therewith. Similarly, users may wish to receive such reports to evaluate actual market share and dose volume or market share trend data by, for example, geographic region, feedlot capacity, and weight. Users may also desire reports regarding whether feedlots are using products per the users' recommendations and other information such as how many days after arrival or slaughter was a product administered or what other products are being used in conjunction with a particular product.

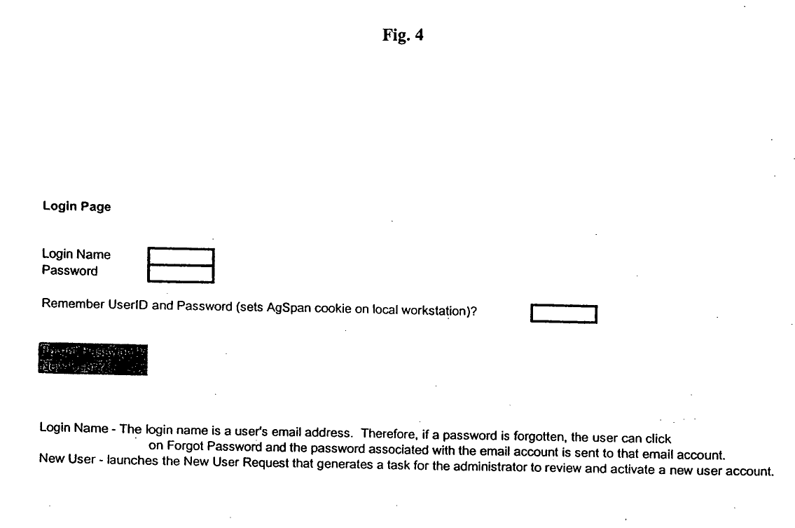

Alternatively, a user may access reports 132 directly from system 10 via a web page. It will be appreciated by those skilled in the art that buttons or drop-down menus may be provided on the web page for ease of selection and linking to appropriate web pages during performance of the method of the present invention. The user logs on to central controller 12 using network interface 86 of user interface 16 thereby establishing a communication link. A unique username and password may be provided to the user which allows information particular to the user to be made available for viewing by the user. The user inputs an assigned username and password into appropriate fields on the web page and the user's identity is verified by transmitting the information to central controller 12 which then matches the username and password against a particular account in user account data repository 61. A representative screen shot of the user log-in page is shown in FIG. 4. If a correct username and password has been provided by the user, central controller 12 transmits that portion of user account data 59 that corresponds to the user's account information to user interface 16. The user may then select to view its account information including, but not limited to, any of data 52, 54, 56, 58, 59 and 60.

A user may select a field(s) from which to search for a desired data set. The user inputs the desired information into the relevant field thereby requesting controller 12 to search within the fields and search criteria inputted. For example, the user may want information regarding feed additive dosages given within a particular date range within user's feedlot. The user would either input or select from drop-down menus these search criteria. Once the search criteria have been selected, the user transmits them to central controller 12. This is done by clicking on a “search” button, or functionally-equivalent action, located on the search screen provided by the graphical user interface. The search criteria are received by controller 12 and checked for matches against data mine 124. Data 58 meeting the search criteria is then copied or otherwise transferred from data mine 124 and transmitted to user interface 16 for viewing by the user. The user may choose to start over and enter new search criteria in fields or the user may choose to refine the search criteria to narrow the number of results achieved. If, however, the user is satisfied with the search results, the user may select a particular data set developed by the search for viewing. Once selected, a screen is provided having the data 58 applicable to the data ranges and feed additive dosages selected by the user thereon. Data 58 may be provided as a report 132 or other easily-viewable format. After reviewing data 58, the user may choose to view additional available data 52, 54, 56, 58, 59 or 60, get a more detailed report containing data 52, 54, 56, 58, 59 or 60, or add raw data 112.

In use, application program 40 instructs central controller 12 to connect to transmission means 14 via network interface 26 and sends, for example, data 58 to user interface 16 which is then displayed for the user in order to aid the user's management of its account and data. Both audio and visual data may be included in data 58 and transmitted in such a manner. Similarly, desired user account data 59 may be inputted into central controller 12 and application program 40 wherein user account data 59 is collected in such a way as to correspond to a specific user. Application program 40 then connects to transmission means 14 via network interface 26 and sends user account data 59 to user interface 16 which is then displayed for the user.

The foregoing description of the embodiments of the invention has been presented for purposes of illustration and description, and is not intended to be exhaustive or to limit the invention to the precise form disclosed. The description was selected to best explain the principles of the invention and practical application of these principles to enable others skilled in the art to best utilize the invention in various embodiments and modifications as are suited to the particular use contemplated. In particular, hardware, software and transmission means have been described for purposes of illustration and description. It will be appreciated by those skilled in the art that any hardware, software, and transmission means now known or hereafter developed that would be suitable for user in the method of the present invention may be used in accordance with the present invention. Furthermore, while the foregoing description of the embodiments of the invention has been presented in the context of the beef cattle industry, the present invention would be suitable for use in any other type of livestock industry such as swine, poultry, dairy cattle, sheep, goats, ostrich, and the like. It is intended that the scope of the invention not be limited by the specification, but be defined by the claims set forth below.

1. A method for managing livestock data comprising the steps of:
collecting raw livestock data from a plurality of livestock data acquisition locations;
determining through an iterative process the validity of said raw livestock data;
normalizing the validated data using a conversion factor based upon the type and unit of measurement for the data; and
presenting the normalized data in a report format.

2. The method of claim 1 further comprising the step of transmitting livestock data from a plurality of livestock data acquisition locations.

3. The method of claim 2 further comprising the step of converting said raw livestock data into a standardized format prior to transmitting said raw data.

4. The method of claim 1 further comprising the step of receiving said raw livestock data in a central repository.

5. The method of claim 4 further comprising the step of validating said raw livestock data using standard deviation parameters and at least one rules engine configured to provide standard minimums and maximums particular to the type of raw data transmitted.

6. The method of claim 5 further comprising the step of transmitting un-validated raw livestock data back to said livestock data acquisition locations.

7. The method of claim 1 further comprising the step of mapping said validated data.

8. The method of claim 7 further comprising the step of converting said validated data into standardized units of measure and inserting the converted data into at least one data collection tool.

9. The method of claim 7 further comprising the step of converting product label data contained in said validated data into a standard format and inserting said label data into at least one data collection tool.

10. The method of claim 1 further comprising the step of matching said validated data using a matching algorithm configured to link data identifying a particular animal, pen or lot.

11. The method of claim 1 further comprising the step of matching said validated data using a matching algorithm configured to link data identifying feed rations and feed ingredients consumed by a particular animal, pen or lot.

12. The method of claim 1 further comprising the step of matching said validated data using a matching algorithm configured to link data identifying pre- and post-slaughter characteristics of a particular animal, pen or lot.

13. The method of claim 1, said livestock data being selected from the group consisting of demographic data, animal health data, feedlot performance data, feed data, carcass data, and user account data.

14. A system for managing livestock data comprising:
means for accessing and collecting livestock data from legacy software applications;
means for transmitting said data to a livestock data management system;
means for validating said data;
means for normalizing said data; and
means for reporting said data.

15. The system of claim 14 further comprising means for converting said raw livestock data into a standardized format prior to transmitting said raw data.

16. The system of claim 14 further comprising means for receiving said raw livestock data in a central repository.

17. The system of claim 16 further comprising means for validating said raw livestock data using standard deviation parameters and at least one rules engine configured to provide standard minimums and maximums particular to the type of raw data transmitted.

18. The system of claim 17 further comprising the step of transmitting un-validated raw livestock data back to said livestock data acquisition locations.

19. The system of claim 14 further comprising means for mapping said validated data.

20. The system of claim 19 further comprising means for converting said validated data into standardized units of measure and inserting the converted data into at least one data collection tool.

21. The system of claim 19 further comprising means for converting product label data contained in said validated data into a standard format and inserting said label data into at least one data collection tool.

22. The system of claim 14 further comprising means for matching said validated data using a matching algorithm configured to link data identifying a particular animal, pen or lot.

23. The system of claim 14 further comprising means for matching said validated data using a matching algorithm configured to link data identifying feed rations and feed ingredients consumed by a particular animal, pen or lot.

24. The system of claim 14 further comprising means for matching said validated data using a matching algorithm configured to link data identifying pre- and post-slaughter characteristics of a particular animal, pen or lot.

25. The system of claim 14, said livestock data being selected from the group consisting of demographic data, animal health data, feedlot performance data, feed data, carcass data, and user account data.
